(19) United States
(12) Patent Application Publication
(10) Pub. No.: US 2026/0045417 A1
(43) Pub. Date: Feb. 12, 2026

(54) Film Capacitor Containing A Polyarylene Sulfide

(71) Applicant: Ticona LLC, Florence, KY (US)

(72) Inventors: Wenqi Li, Shanghai (CN); Yuehua Yu, Cincinnati, OH (US); Fangfang Tao, Shanghai (CN)

(21) Appl. No.: 19/263,572

(22) Filed: Jul. 9, 2025

Related U.S. Application Data
(60) Provisional application No. 63/679,764, filed on Aug. 6, 2024.

(51) Int. Cl. H01G 4/224; H01G 4/232; H01G 4/32; H01G 4/33; H01G 4/40; H01G 13/00

(52) U.S. Cl. CPC H01G 4/224; H01G 4/232; H01G 4/32; H01G 4/33; H01G 4/40; H01G 13/003

(57) ABSTRACT

A film capacitor comprising a capacitor element that includes first metallized films electrically connected to a first termination and second metallized films electrically connected to a second termination, and a case within which the capacitor element is disposed, is provided. The case contains a polymer composition that includes 100 parts by weight of a polymer matrix that contains a polyarylene sulfide, from about 30 to about 90 parts by weight of inorganic fibers, and a zinc (II) compound.

### RELATED APPLICATION

The present application is based upon and claims priority to U.S. Provisional Patent Application Ser. No. 63/679,764, having a filing date of Aug. 6, 2024, which is incorporated herein by reference.

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains an electric propulsion source (e.g., battery) and a transmission. For example, the powertrain may include an inverter that can produce alternating current (AC) from direct current (DC). To accomplish this conversion, the inverter may, for instance, employ a bridge circuit that includes a film capacitor in combination with one or more diodes and switching elements (e.g., transistors). The film capacitor generally includes an outer case formed from high performance polymer materials to help protect the interior capacitor element from the external environment. A filling resin (e.g., epoxy resin) may also be disposed in the space between the outer case and the capacitor element to help mechanically stabilize the capacitor element during use. Unfortunately, during the molding operation used to form the case, most conventional polymer materials tend to leave residual deposits on the surface of the part or molding tool. Based on the very small size of film capacitors, these deposits often create unwanted marks, which can cause the part to be rejected. As such, a need currently exists for an improved polymer composition for use in a film capacitor that has a reduced likelihood of creating residual deposits during a molding operation.

### SUMMARY OF THE INVENTION

In accordance with one embodiment of the present invention, a film capacitor is disclosed that comprises a capacitor element that includes first metallized films electrically connected to a first termination and second metallized films electrically connected to a second termination. The capacitor also contains a case within which the capacitor element is disposed. The case contains a polymer composition that includes 100 parts by weight of a polymer matrix that contains a polyarylene sulfide, from about 30 to about 90 parts by weight of inorganic fibers, and a zinc (II) compound.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1A is a schematic cross-sectional view of one embodiment of a film capacitor of the present invention;

FIG. 1B is a cross-sectional view taken along the line A-A FIG. 1A;

FIG. 2A is a schematic perspective view of one embodiment of a capacitor element defining the film capacitor;

FIG. 2B is a cross-sectional view taken along the line B-B in FIG. 2A;

FIG. 3 is a schematic perspective view of one embodiment of a wound body shown in FIGS. 2A and 2B;

FIG. 4 is a schematic perspective view of another embodiment of the wound body shown in FIGS. 2A and 2B;

FIG. 5A, FIG. 5B, and FIG. 5C are schematic diagrams of one embodiment of a method of producing a film capacitor;

FIG. 6 illustrates an electric vehicle including components that may incorporate the film capacitor of the present invention;

FIG. 7 illustrates an inverter system as may be present in an electric car including components that may incorporate the film capacitor of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a film capacitor comprising a capacitor element that includes first metallized films electrically connected to a first termination and second metallized films electrically connected to a second termination, and a case within which the capacitor element is disposed. The case contains a polymer composition that includes a polymer matrix that contains a polyarylene sulfide, inorganic fibers, and a zinc (II) compound. By selectively controlling the particular nature of the components of the polymer composition, as well as their relative concentration, the present inventors have discovered that the resulting polymer composition can minimize the condensation of residual deposits on the surface of the capacitor during a molding process, which would otherwise create unwanted marks on the molding tool or part surface. In addition to minimizing residual deposits, the polymer composition may also still exhibit good flowability as reflected by a relatively low melt viscosity, such as about 800 Pa-s or less, in some embodiments about 600 Pa-s or less, in some embodiments about 500 Pa-s or less, and in some embodiments, from about 50 to about 400 Pa-s, as determined in accordance with ISO 11443:2021 at a temperature of about 310° C. and at a shear rate of 400 s⁻¹.

Despite having a low melt viscosity, the polymer composition may nevertheless maintain a high degree of strength, which can provide enhanced flexibility for the resulting structure. For example, the polymer composition may exhibit a Charpy notched impact strength of about 5 KJ/m² or more, such as in some embodiments from about 6 to about 30 KJ/m², and in some embodiments, from about 7 to about 20 KJ/m², as determined at a temperature of 23° C. in accordance with ISO 179-1:2010. The composition may also exhibit good tensile properties, such as a tensile strength of about 50 MPa or more, in some embodiments from about 80 MPa to about 250 MPa, and in some embodiments, from about 100 to about 200 MPa; a tensile break strain of about 1% or more, in some embodiments from about 1.2% to about 5%; and/or a tensile modulus of about 8,000 MPa or more, in some embodiments from about 10,000 MPa to about 20,000 MPa, in some embodiments from about 12,000 MPa to about 18,000 MPa. The tensile properties may be determined in accordance with ISO 527:2019 at a temperature of 23° C. The composition may also exhibit a flexural strength of about 50 MPa or more, in some embodiments from about 100 to about 350 MPa, and in some embodiments from about 200 to about 300 MPa, and/or a flexural modulus of from about 5,000 to about 20,000, in some embodiments from about 10,000 MPa to about 18,000 MPa, and in some embodiments, from about 12,000 MPa to about 16,000 MPa. The flexural properties may be determined in accordance with ISO 178:2019 at a temperature of 23° C.

Various embodiments of the present invention will now be described in greater detail below.

### I. Polymer Composition

### A. Polymer Matrix

The polymer matrix typically constitutes from about 30 wt. % to about 75 wt. %, in some embodiments from about 40 wt. % to about 70 wt. %, and in some embodiments, from about 45 wt. % to about 65 wt. % of the polymer composition. The polymer matrix generally contains at least one polyarylene sulfide. For example, polyarylene sulfides typically constitute from about 50 wt. % to 100 wt. %, in some embodiments from about 70 wt. % to 100 wt. %, and in some embodiments, from about 90 wt. % to 100 wt. % of the polymer matrix (e.g., 100 wt. %).

The polyarylene sulfide may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

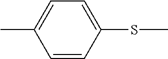

and segments having the structure of formula:

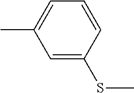

or segments having the structure of formula:

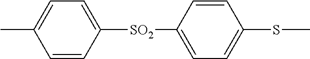

The polyarylene sulfide may be linear, semi-linear, branched, or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between any impact modifiers and the polyarylene sulfide, which can improve distribution of the impact modifier throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

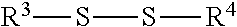

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

The polymer matrix may exhibit a melt flow index of greater than about 250 grams per 10 minutes, in some embodiments greater than about 300 grams per 10 minutes, and in some embodiments, from about 350 to about 900 grams per 10 minutes, as determined in accordance with ASTM D1238-13 at a load of 2.16 kg and temperature of 190° C. The target melt flow index may be achieved through the use of a single polyarylene sulfide or through the use of a blend of polyarylene sulfides having different melt flow indices. In one embodiment, for example, the polymer matrix may employ a first polyarylene sulfide having a first melt flow index and a second polyarylene sulfide having a second melt flow index. The ratio of the first melt flow index to the second melt flow index may, for example, be from about 1.5 to about 4, in some embodiments from about 1.8 to about 3.2, and in some embodiments, from about 2 to about 3. The first melt flow index may, for example, range from about 300 to about 700, in some embodiments from about 350 to about 650, and in some embodiments, from about 400 to about 600 grams per 10 minutes. Likewise, the second melt flow index may range from about 50 to about 300, in some embodiments from about 100 to about 250, and in some embodiments, from about 120 to about 220 grams per 10 minutes. Depending on the exact melt flow indices chosen, the relative weight percentage of each polymer may thus be selectively controlled to achieve the target melt flow index for the polymer matrix. Typically, for example, the first polyarylene sulfide and the second polyarylene sulfide each constitutes from about 30 wt. % to about 70 wt. %, in some embodiments from about 35 wt. % to about 65 wt. %, and in some embodiments, from about 40 wt. % to about 60 wt. % of the polymer matrix.

### B. Inorganic Fibers

As noted above, the polymer composition may also contain inorganic fibers, such as in an amount of from about 30 to about 90 parts by weight, in some embodiments from about 40 parts to about 80 parts by weight, and in some embodiments, from about 50 parts to about 75 parts by weight per 100 parts by weight of the polymer matrix. The inorganic fibers may, for instance, constitute from about 10 wt. % to about 60 wt. %, in some embodiments from about 20 wt. % to about 55 wt. %, and in some embodiments, from about 30 wt. % to about 50 wt. % of the polymer composition.

Suitable inorganic fibers may include those derived from glass; titanates (e.g., potassium titanate); silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers may be particularly suitable, such as those formed from E-glass, A-glass, C-glass, D-glass, AR-glass, R-glass, S1-glass, S2-glass, etc., as well as mixtures thereof. Further, although the fibers may have a variety of different sizes, fibers having a certain size can help improve the mechanical properties of the resulting polymer composition. The inorganic fibers may, for example, have an average diameter of from about 1 micrometers to about 50 micrometers, in some embodiments from about 5 micrometers to about 40 micrometers, in some embodiments from about 6 micrometers to about 30 micrometers, and in some embodiments from about 8 micrometers to about 15 micrometers, such as determined in accordance with ISO 1888:2022. The fibers may be endless or chopped fibers, such as those having a length of from about 1 to about 15 millimeters, and in some embodiments, from about 2 to about 6 millimeters.

If desired, the inorganic fibers may contain a sizing composition coated thereon to help further enhance the ability of the composition used in a laser welding process. The sizing composition may include an organosilane compound that is capable of forming Si—O—Si covalent bonds between the glass fiber surface and silanols obtained by hydrolysis of the silane compound, as well as between adjacent silanol groups. The resulting covalent bonds forms a crosslinked structure at the surface of the fibers that can the properties of the fibers. Such organosilane compounds may, for instance, constitute from about 2 wt. % to about 40 wt. %, in some embodiments from about 2.5 wt. % to about 20 wt. %, and in some embodiments, from about 5 wt. to about 15 wt. % of the solids content of the sizing composition (i.e., excluding water). The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

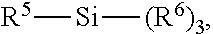

wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;
R⁶ is an alkoxy group of from 1 to 10 carbon atoms, such as methoxy, ethoxy, propoxy, and so forth.

Aminosilane compounds are particularly suitable and may include monomeric or oligomeric (<6 units) silanes. Aminotrialkoxysilanes may be employed in certain embodiments to form a three dimensional network of Si—O—Si covalent bonds at the surface and around the surface of the fibers. Aminodialkoxysilanes may likewise be employed in certain embodiments to form a hairlike structure on the surface of the fibers. While not necessarily forming a three-dimensional crosslinked protective sheath around the fibers, the dialkoxysilanes may nevertheless facilitate impregnation of the fiber bundles and wetting of the individual fibers by a polymer melt. Thus, it may be desirable to employ trialkoxysilanes, dialkoxysilanes, or mixtures thereof in the sizing composition. Specific examples of suitable aminosilanes may include, for instance, aminodialkoxysilanes, such as γ-aminopropylmethyldiethoxysilane, N-β-(Aminoethyl)-gamma-aminopropylmethyldimethoxysilane, N-β-(Aminoethyl)-γ-aminopropyl-methyldimethoxysilane, N-β-(Aminoethyl)-γ-aminoisobutylmethyldimethoxy-silane, γ-aminopropylmethyldimethoxysilane, N-β-(Aminoethyl)-γ-aminopropyl-methyldiethoxysilane, etc.; aminotrialkoxysilanes, such as γ-aminopropyltriethoxysilane, γ-aminopropyltri-methoxysilane, N-β-(Aminoethyl)-γ-aminopropyl-trimethoxysilane, N-β-(Aminoethyl)-γ-aminopropyltriethoxysilane, diethylene-triaminopropyltrimethoxysilane, Bis-(γ-trimethoxysilylpropyl) amine, N-phenyl-γ-aminopropyltrimethoxysilane, γ-amino-3,3-dimethylbutyltrimethoxysilane, γ-aminobutyltriethoxysilane, etc.; as well as mixtures of any of the foregoing.

### C. Zinc (II) Compound

As indicated above, a zinc (II) compound is also employed in the polymer composition. The zinc (II) compound may be incorporated into the polymer composition by melt compounding the polymer matrix and inorganic fibers in the presence of the compound such that it is present in an amount of from about 0.05 to about 3 parts by weight, in some embodiments from about 0.1 to about 2 parts by weight, and in some embodiments, from about 0.2 to about 1 parts by weight per 100 parts by weight of the polymer matrix. The zinc (II) compound may, for instance, constitute from about 0.01 wt. % to about 1.5 wt. %, in some embodiments from about 0.05 wt. % to about 1 wt. %, and in some embodiments, from about 0.1 wt. % to about 0.6 wt. % of the polymer composition. Without intending to be limited by theory, it is believed that the zinc (II) compound is capable of functioning as a reducing agent to form stable covalent sulfides from disulfide radical impurities that are inadvertently formed during the polymerization process of the polyarylene sulfide. This minimizes the tendency of the radical impurities from catalyzing oxidation and chain scission under heat, which would otherwise lead to condensation of volatiles on the surface of the capacitor. Moreover, the zinc (II) compound is synergistically also capable of serving as an effective mold release agent, thus further minimizing the likelihood that the polymer composition will deposit residues onto a surface of the part and/or molding tool during molding.

Any of a variety of zinc (II) compounds may generally be employed. For example, the zinc (II) compound may be an organic salt, such as a zinc (II) carboxylate. The carboxylic acid used to form such carboxylate salts may generally be any saturated or unsaturated acid having a carbon chain length of from about 2 to 22 carbon atoms, in some embodiments from 4 to 20 carbon atoms, in some embodiments from 8 to 20 carbon atoms, and in some embodiments, from about 10 to about 18 carbon atoms. If desired, the acid may be substituted. Suitable fatty acids may include, for instance, acetic acid, lauric acid, myristic acid, behenic acid, oleic acid, palmitic acid, stearic acid, ricinoleic acid, capric acid, neodecanoic acid, hydrogenated tallow fatty acid, hydroxy stearic acid, the fatty acids of hydrogenated castor oil, erucic acid, coconut oil fatty acid, etc., as well as mixtures thereof. Stearic acid may be particularly suitable so that the resulting salt is zinc stearate. Of course, other suitable zinc (II) carboxylates may include, for instance, zinc acetate, zinc octanoate, zinc 2-ethylhexanoate, etc., as well as combinations thereof. Of course, besides salts (e.g., carboxylates), other zinc (II) compounds may also be employed. In another embodiment, for example, an organic zinc (II) oxide may be employed, such as zinc oxide.

The temperature at which the zinc (II) compound melts (“melting point”) and/or burns (“flash point”) is also typically relatively high, which further minimizes the creation of deposits on a surface during a molding operation. Namely, the zinc (II) compound may have a melting point and flash point greater than about 85° C., in embodiments greater than about 90° C., in some embodiments greater than about 95° C., and in some embodiments, from about 100° C. to about 2000° C. In this regard, the polymer composition may also be generally free of mold release additives having a melting temperature below about 70° C., in some embodiments below about 75° C., in some embodiments below about 80° C., and in some embodiments, below about 85° C. By “generally free”, it is contemplated that such additives are completely absent from the composition or, at the very least, present in only trace amounts. For example, such release additives are generally present in an amount of about 1,000 parts per million (“ppm’) or less, in some embodiments about 500 ppm or less, in some embodiments about 100 ppm or less, and in some embodiments, about 50 ppm or less (e.g., 0 ppm). Specific examples of release additives that have a melting temperature below 85° C. are polyglycerol fatty acid esters, such as pentaerythrityl-tetrastearate (melting point of about 60° C.), glycol distearate (melting point of about 65-73° C.), glycol stearate (melting point of about 55-60° C.), glycerol monostearate (melting point of about 57-65° C.), etc.

### D. Optional Components

In addition to the components noted above, the polymer composition may also contain a variety of other optional components to help improve its overall properties. Examples of such components may include, for instance, colorants (e.g., black colorants), stabilizers (e.g., heat stabilizers, UV stabilizers, antioxidants, etc.), coupling agents, impact modifiers, crosslinking agents, surfactants, waxes, flow promoters, solid solvents, and other materials added to enhance properties and processability. In one embodiment, for example, an organosilane coupling agent may also be employed in the polymer composition, such as in an amount of from about 0.1 to about 3 parts by weight, in some embodiments from about 0.15 to about 1.5 parts by weight, and in some embodiments, from about 0.2 to about 0.8 parts by weight per 100 parts by weight of the polymer matrix. For example, organosilane compounds can constitute from about 0.05 wt. % to about 2 wt. %, in some embodiments from about 0.1 wt. % to about 1.5 wt. %, and in some embodiments, from about 0.2 to about 0.8 wt. % of the polymer composition. The organosilane coupling agent may, for example, be an alkoxysilane such as those having the general formula of the organosilanes referenced above. Particularly suitable organosilane coupling agents are 3-aminopropyltriethoxysilane and 3-mercaptopropyltrimethoxysilane.

### II. Melt Compounding

The manner in which the polyarylene sulfide(s), inorganic fibers, zinc (II) compound, and various other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

### III. Film Capacitor

As indicated above, the unique properties of the polymer composition can more readily allow it to be more readily employed in a film capacitor. In certain embodiments, for example, the film may contain a capacitor element that is positioned within a case. The capacitor element may, for example, be a laminate (e.g., wound laminate) that includes one or more first metallized films that are electrically connected to a first external termination and one or more second metallized films that are electrically connected to a second external termination. The film may be formed from a polymer composition that includes a thermoplastic resin, such as a polyolefin (e.g., polypropylene), polyethersulfone, polyetherimide, polyarylate, urethane, etc. The thickness of the film is typically about 5 micrometers or less, in some embodiments about 3.5 micrometers or less, and in some embodiments, from about 0.5 to about 3 micrometers. The films may be metallized by forming a metal layer on one or both surfaces thereof. The metal layer(s) may contain a metal, such as aluminum, titanium, zinc, magnesium, tin, nickel, etc. Any technique may be used to form the metal layers as is known in the art. For example, the metal layers may be sprayed, vapor-deposited, etc. onto the films. The thickness of each metal layer is typically about 5 micrometers or less, in some embodiments about 100 nanometers or less, and in some embodiments, from about 5 to about 40 nanometers.

The volume of the capacitor element is typically from about 30% to about 85% relative to the inner volume of the case so that a space is formed between an inner surface of the case and an outer surface of the capacitor element. The space may range, for example, from about 1 to about 5 millimeters, and in some embodiments, from about 1 to about 2 millimeters. The capacitor element may have an oblong cross section having a major axis of from about 15 to about 65 millimeters and a minor axis of from about 2 to about 50 millimeters, and the length of the capacitor element in a longitudinal direction (a direction from a front cross section to a rear cross section, including the external electrodes) may be from about 10 to about 50 millimeters. The case may likewise have an outer shape in which the long side of the bottom is from about 16 to about 73 millimeters, the short side of the bottom is from about 3 to about 78 millimeters, the height is from about 10.5 to about 50.5 millimeters, and the thickness is from about 0.5 to about 3 millimeters.

Regardless of the particular size and shape, a resinous material may be disposed within the case so that it is contact with the capacitor element and case and occupies at least a portion, if not all, of the space defined between the case and the capacitor element. The resinous material typically contains a thermoset resin, such as an epoxy resin, vinyl ester resin, urethane resin, phenolic resin, etc. Epoxy resins may be particularly suitable for use in the composite structure, such as bisphenol A type epoxy resins, bisphenol F type epoxy resins, phenol novolac type epoxy resins, orthocresol novolac type epoxy resins, brominated epoxy resins and biphenyl type epoxy resins, cyclic aliphatic epoxy resins, glycidyl ester type epoxy resins, glycidylamine type epoxy resins, cresol novolac type epoxy resins, naphthalene type epoxy resins, phenol aralkyl type epoxy resins, cyclopentadiene type epoxy resins, heterocyclic epoxy resins, etc. Epoxy phenol novolac (“EPN”) resins, which are glycidyl ethers of phenolic novolac resins, may be particularly suitable. Specific examples of novolac-type epoxy resins may include a phenol-novolac epoxy resin, cresol-novolac epoxy resin, naphthol-novolac epoxy resin, naphthol-phenol co-condensation novolac epoxy resin, naphthol-cresol co-condensation novolac epoxy resin, brominated phenol-novolac epoxy resin, etc. If desired, the epoxy resin may be crosslinked with a co-reactant (hardener). Examples of such co-reactants may include, for instance, polyamides, amidoamines (e.g., aromatic amidoamines such as aminobenzamides, aminobenzanilides, and am inobenzenesulfonam ides), aromatic diamines (e.g., diaminodiphenylmethane, diaminodiphenylsulfone, etc.), aminobenzoates (e.g., trimethylene glycol di-p-aminobenzoate and neopentyl glycol di-p-amino-benzoate), aliphatic amines (e.g., triethylenetetramine, isophoronediamine), cycloaliphatic amines (e.g., isophorone diamine), imidazole derivatives, guanidines (e.g., tetramethylguanidine), carboxylic acid anhydrides (e.g., methylhexahydrophthalic anhydride), carboxylic acid hydrazides (e.g., adipic acid hydrazide), phenolic-novolac resins (e.g., phenol novolac, cresol novolac, etc.), carboxylic acid amides, etc., as well as combinations thereof.

In addition to a thermoset resin and optional co-reactants, the resinous material also typically contains one or more inorganic oxide fillers, such as silica, alumina, zirconia, magnesium oxides, iron oxides (e.g., iron hydroxide oxide yellow), titanium oxides (e.g., titanium dioxide), zinc oxides (e.g., boron zinc hydroxide oxide), copper oxides, zeolites, silicates, clays (e.g., smectite clay), etc., as well as composites (e.g., alumina-coated silica particles) and mixtures thereof. Silica is particularly suitable for use in the resinous material. To help improve overall moisture resistance, the content of the inorganic oxide fillers may be maintained at a high level, such as about 50 wt. % or more, in some embodiments about 60 wt. % or more, and in some embodiments, from about 70 wt. % to about 90 wt. % of the resinous material. The thermoset resin (optionally reacted with co-reactants) likewise typically constitutes from about 0.5 wt. % to about 40 wt. %, in some embodiments from about 1 wt. % to about 35 wt. %, and in some embodiments, from about 5 wt. % to about 30 wt. % of the composition. Apart from the components noted above, it should be understood that still other additives may also be employed in the resinous material, such as photoinitiators, viscosity modifiers, suspension aiding agents, pigments, stress reducing agents, coupling agents (e.g., silane coupling agents), stabilizers, etc. When employed, such additives typically constitute from about 0.1 to about 20 wt. % of the resinous material.

The case may be formed from the polymer composition such that the resulting contact between the case and the resinous material forms a composite structure. The polymer composition may be formed into a layer (e.g., “first layer”) of the composite structure using a variety of techniques, such as by molding, film formation, extrusion, etc. In one embodiment, for example, the polymer composition may be molded into the desired shaper for the first layer. Suitable molding techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity.

The layer formed from the resinous material (e.g., “second layer”) may be incorporated into the composite structure before, during, or after the first layer is formed. When the first layer is molded, for example, the resinous material may be coated, poured, dipped, injected, or otherwise applied to the first layer and crosslinked to form the second layer. The thermoset resinous material may be initially provided in the form of a single or multiple compositions. For instance, a first composition may contain the thermoset resin and the second composition may contain the co-reactant. Regardless, once it is applied, the thermoset resinous material may be heated or allowed to stand at ambient temperatures so that the thermoset resin is allowed to crosslink with the co-reactant, which thereby causes the material to cure and harden into the desired shape. For instance, the composition may be heated to a temperature of from about 15° C. to about 150° C., in some embodiments from about 20° C. to about 120° C., and in some embodiments, from about 25° C. to about 100° C. Alternatively, the second layer may be pre-formed and the polymer composition may simply be molded onto or otherwise formed on the second layer to form the first layer of the composite structure.

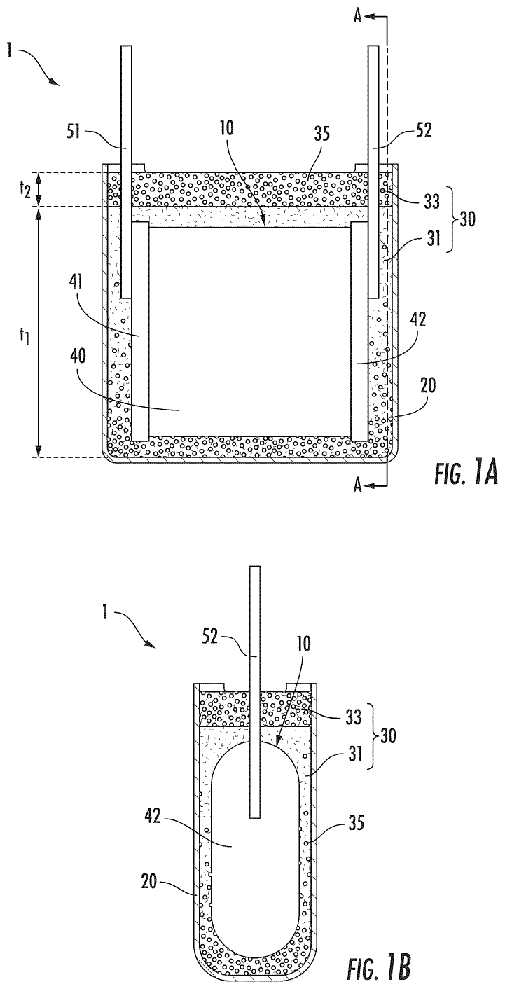

Referring to FIGS. 1A and 1B, for example, one embodiment of a film capacitor 1 is shown that includes a capacitor element 10. In the illustrated embodiment, the capacitor element 10 includes a wound body 40 of metallized films and a first external electrode 41 and a second external electrode 42 at the respective ends of the wound body 40. A first termination 51 is connected to the first external electrode 41, and a second termination 52 is connected to the second external electrode 42. The capacitor 1 also contains a case 20 that houses the capacitor element 10 and has a bottomed tubular shape having an opening at one end. The case 20 may be formed from the polymer composition described herein. In one embodiment, for example, the case may be formed by injection molding the polymer composition into the desired shape. In the film capacitor 1 shown, a rectangular parallelepiped space is formed in the case 20, and the capacitor element 10 is disposed apart from inner surfaces of the case 20 and centered in the case 20. To help hold and seal the capacitor element 10 within the case 20, the space between outer surfaces of the capacitor element 10 and the inner surfaces of the case 20 may be filled with a resinous material 30 as described above. Although by no means required, the resinous material 30 in the depicted embodiment includes a first resin layer 31 surrounding the capacitor element 10 from the bottom of the case 20 and a second resin layer 33 disposed closer to an opening of the case 20 than the first resin layer 31. The first and/or second resin layers may be formed from the resinous material as described above. In this manner, a composite structure is formed that includes the case 20, the first resin layer 31, and the second resin layer 33. If desired, a thickness t₂ of the second resin layer 33 may be smaller than a thickness t₁ of the first resin layer 31. For example, the thickness of the second resin layer may be about 50% or less, in some embodiments about 30% or less, and in some embodiments, about 15% or less of the thickness of a total thickness of both the first and second resin layers.

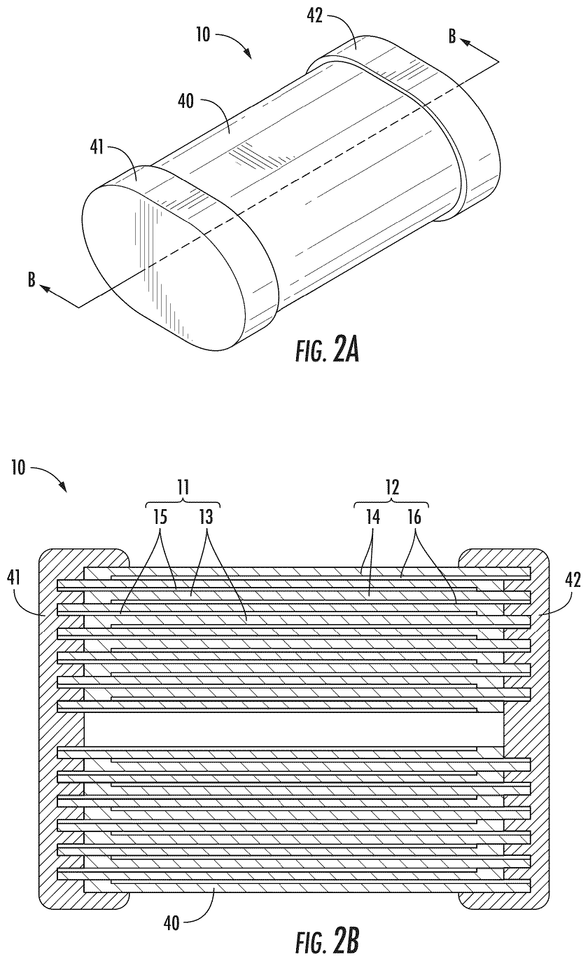

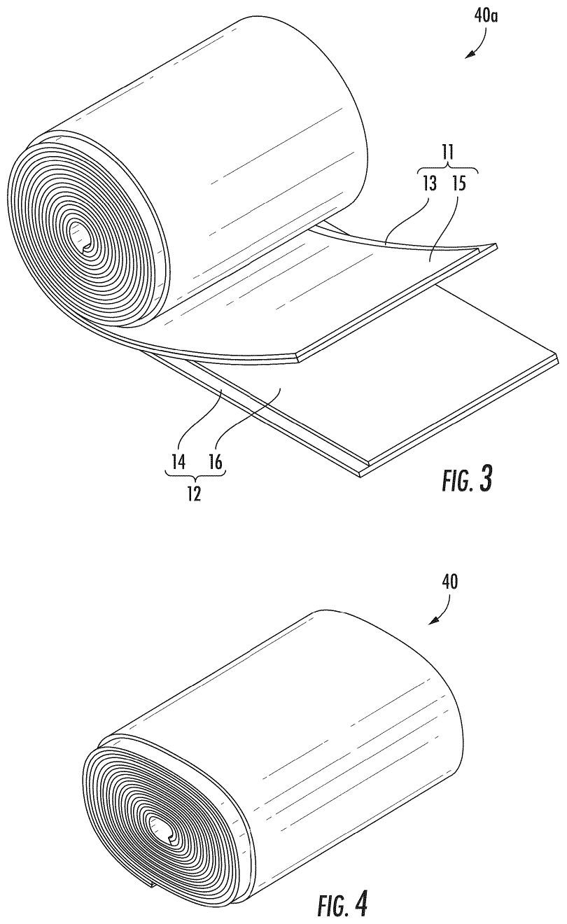

The capacitor element may have a pillar shape and an oblong cross section, and may include external electrodes formed by, for example, metal spraying at both ends of the pillar shape in the central axis direction. FIGS. 2A and B show one particular embodiment of the capacitor element that may be employed. As shown, the capacitor element 10 includes a wound body 40 of metallized films, each metallized film including a first metallized film 11 and a second metallized film 12 wound in a laminated state, and the first external electrode 41 and the second external electrode 42 connected to both end faces of the wound body 40. As shown in FIG. 2B, the first metallized film 11 may include a first resin film 13 and a first metal layer (counter electrode) 15 on a surface of the first resin film 13. The second metallized film 12 may include a second resin film 14 and a second metal layer (counter electrode) 16 on a surface of the second resin film 14. The first metal layer 15 and the second metal layer 16 oppose each other with the first resin film 13 or the second resin film 14 therebetween. Further, the first metal layer 15 is electrically connected to the first external electrode 41, and the second metal layer 16 is electrically connected to the second external electrode 42. The first metal layer 15 may be formed on one side of the first resin film 13 so that it extends to a first end but not to a second end. The second metal layer 16 may be formed on one side of the second resin film 14 so that it extends to the second end but not to the first end. The first external electrode 41 and the second external electrode 42 may be formed by, for example, spraying a metal (e.g., zinc) onto both end surfaces of the wound body 40 of the metallized films. The first external electrode 41 is in contact with the exposed end of the first metal layer 15, and is thus electrically connected to the first metal layer 15. The second external electrode 42 is in contact with the exposed end of the second metal layer 16, and is thus electrically connected to the second metal layer 16.

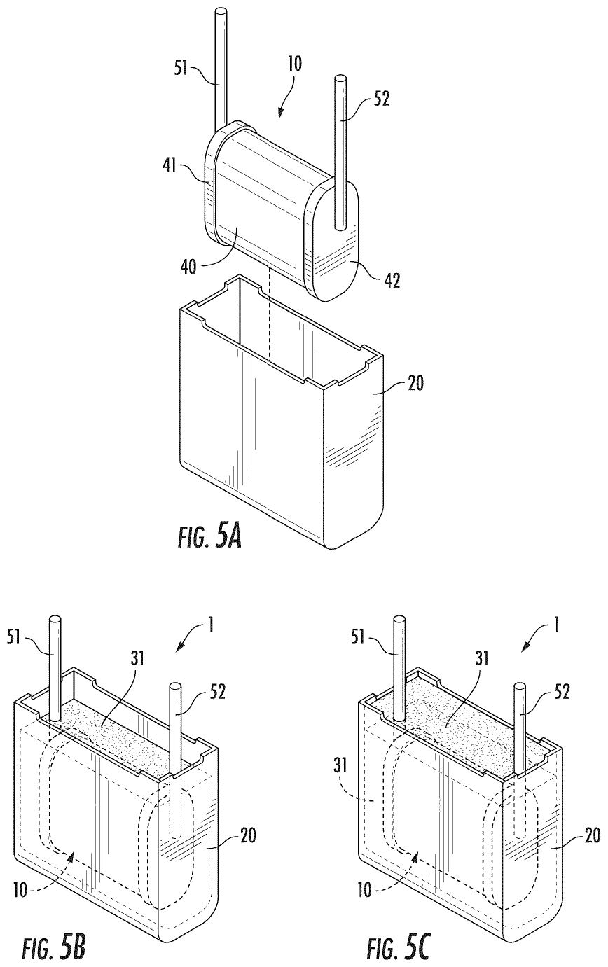

FIG. 3 is a schematic perspective view of one embodiment of a wound body shown in FIGS. 2A and 2B. As shown, the first resin film 13 and the second resin film 14 are laminated in a displaced relationship from each other in a width direction (in FIG. 2B, in a left-to-right direction) so that one end of the first metal layer 15 is exposed from the laminate and that one end of the second metal layer 16 is also exposed from the laminate. The first resin film 13 and the second resin film 14 may be wound in a laminated state into the wound body 40a. The first metal layer 15 and the second metal layer 16 are laminated while they maintain a state in which one end of the first metal layer 15 and one end of the second metal layer 16 are exposed. The first resin film 13 and the second resin film 14 may also be wound so that the second resin film 14 is outside the first resin film 13 and that the first metal layer 15 and the second metal layer 16 face inside. FIG. 4 is a schematic perspective view of another embodiment of the wound body 40 shown in FIGS. 2A and 2B. The wound body 40 of this embodiment may be formed by pressing the wound body 40a (FIG. 4) into a flat cross-sectional shape.

FIGS. 5A-5C are schematic diagrams of one example of the method of producing the film capacitor 1. As shown in FIG. 5A, the first external electrode 41 and the second external electrode 42 are formed on the respective ends of the wound body 40, the first lead terminal 51 and the second lead terminal 52 are welded to provide the capacitor element 10, and the capacitor element 10 is housed in the case 20. Then, as shown in FIG. 5B, the case 20 is filled with a thermoset resinous material, which is cured to form the first resin layer 31. Finally, as shown in FIG. 5C, an additional resinous material may be poured over the first resin layer 31 and cured to form the second resin layer 33.

### IV. Electrical Vehicle

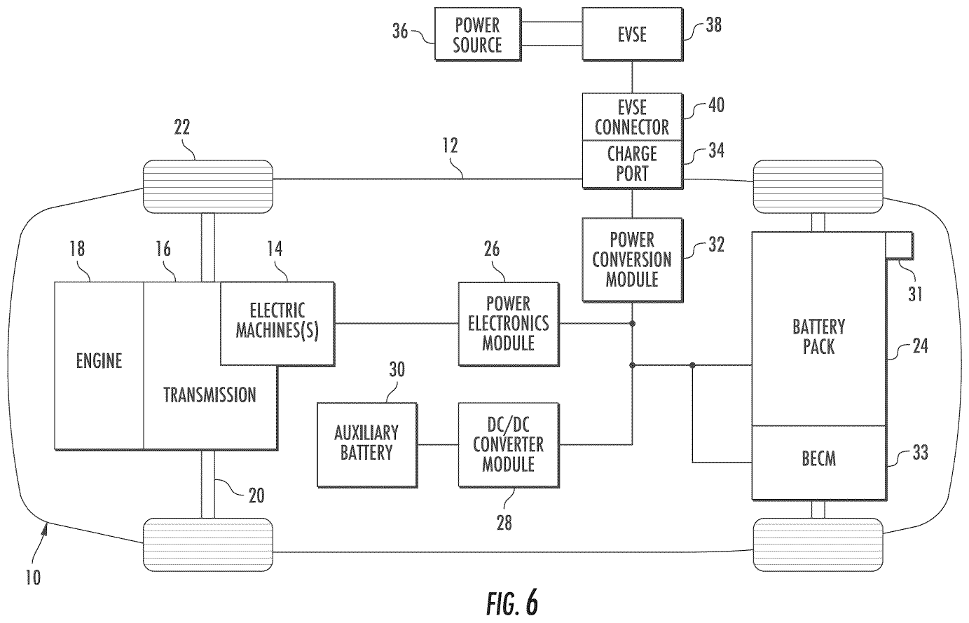

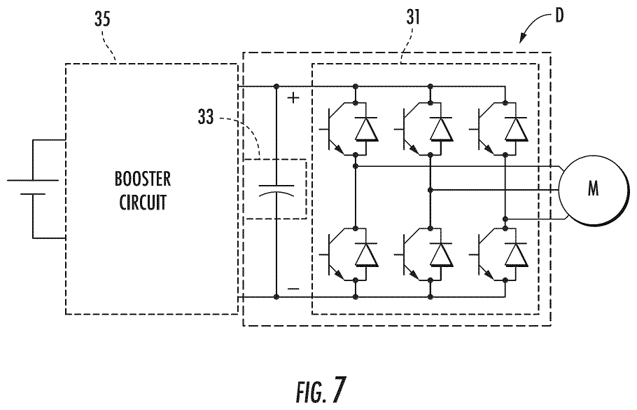

While the film capacitor referenced above may be employed in a wide variety of applications, the present inventors have discovered that such components are particularly suitable for use in a powertrain of an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. Referring to FIG. 6, for instance, one embodiment of an electric vehicle 12 that includes a powertrain 10 is shown. The powertrain 10 contains one or more electric machines 14 connected to a transmission 16, which in turn is mechanically connected to a drive shaft 20 and drive wheels 22. Although by no means required, the transmission 16 in this particular embodiment is also connected to an engine 18, though the description herein is equally applicable to a pure electric vehicle. The electric machines 14 may be capable of operating as a motor or a generator to provide propulsion and deceleration capability. The powertrain 10 also includes a propulsion source, such as a battery assembly 24, which stores and provides energy for use by the electric machines 14. The battery assembly 24 typically provides a high voltage current output (e.g., DC current at a voltage of from about 400 volts to about 800 volts) from one or more battery cell arrays that may include one or more battery cells.

The powertrain 10 may also contain at least one power electronics module 26 that is connected to the battery assembly 24 (also commonly referred to as a battery pack) and that may contain a power converter (e.g., converter, inverter, etc., as well as combinations thereof). The power electronics module 26 is typically electrically connected to the electric machines 14 and provides the ability to bi-directionally transfer electrical energy between the battery assembly 24 and the electric machines 14. For example, the battery assembly 24 may provide a DC voltage while the electric machines 14 may require a three-phase AC voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the battery assembly 24. The battery assembly 24 may also provide energy for other vehicle electrical systems. For example, the powertrain may employ a DC/DC converter module 28 that converts the high voltage DC output from the battery assembly 24 to a low voltage DC supply that is compatible with other vehicle loads, such as compressors and electric heaters. In a typical vehicle, the low-voltage systems are electrically connected to an auxiliary battery 30 (e.g., 12V battery). A battery energy control module (BECM) 33 may also be present that is in communication with the battery assembly 24 that acts as a controller for the battery assembly 24 and may include an electronic monitoring system that manages temperature and charge state of each of the battery cells. The battery assembly 24 may also have a temperature sensor 31, such as a thermistor or other temperature gauge. The temperature sensor 31 may be in communication with the BECM 33 to provide temperature data regarding the battery assembly 24. The temperature sensor 31 may also be located on or near the battery cells within the traction battery 24. It is also contemplated that more than one temperature sensor 31 may be used to monitor temperature of the battery cells. In certain embodiments, the battery assembly 24 may be recharged by an external power source 36, such as an electrical outlet. The external power source 36 may be electrically connected to electric vehicle supply equipment (EVSE) that regulates and manages the transfer of electrical energy between the power source 36 and the vehicle 12. The EVSE 38 may have a charge connector 40 for plugging into a charge port 34 of the vehicle 12. The charge port 34 may be any type of port configured to transfer power from the EVSE 38 to the vehicle 12 and may be electrically connected to a charger or on-board power conversion module 32. The power conversion module 32 may condition the power supplied from the EVSE 138 to provide the proper voltage and current levels to the battery assembly 24. The power conversion module 32 may interface with the EVSE 38 to coordinate the delivery of power to the vehicle 12.

While not specifically illustrated, various electronic components of the powertrain 10 may employ the film capacitor of the present invention. For example, the film capacitor may be employed in the power conversion module 32, power electronics module 26, battery energy control module (BECM) 33, etc. For example, the film capacitor may be particularly useful in a converter and/or inverter of a power conversion module 32. Referring to FIG. 7, for example, one embodiment of an inverter D is shown that can produce alternating current (AC) from direct current (DC). As illustrated, the inverter D may include a bridge circuit 31 that contains a capacitor 33 disposed across input terminals of the bridge circuit 31 for voltage stabilization. If desired, the film capacitor described above may be used as the capacitor 33. The bridge circuit 31 may also contain other electrical component as is known the art, such as diodes, switching elements (e.g., Insulated Gate Bipolar Transistor (IGBT)), etc. The inverter D is also connected to a booster circuit 35 for boosting the voltage of a direct current power supply and a motor generator (a motor M) serving as a driving source. Of course, the use of the film capacitor is in no way limited to only electrical systems. For example, a thermal management system can also beneficially incorporate the capacitor. A thermal management system of an electric vehicle can generally include multiple different subsystems such as, without limitation, refrigeration subsystem, battery cooling subsystem, and heating, ventilation, and cooling (HVAC) subsystem. In some embodiments, one or more subsystems of a thermal management system may in fluid communication with one another, thus allowing hot heat transfer medium to flow from the high temperature circuit into the low temperature circuit, and cooler heat transfer medium to flow from the low temperature circuit into the high temperature circuit.

The present invention may be better understood with reference to the following examples.

### Test Methods

Melt Viscosity: The melt viscosity (Pa-s) may be determined in accordance with ISO 11443:2021 at a shear rate of 400 s⁻¹ and using a Dynisco LCR7000 capillary rheometer. The rheometer orifice (die) may have a diameter of 1 mm, length of 20 mm, L/D ratio of 20.1, and an entrance angle of 180°. The diameter of the barrel may be 9.55 mm+0.007 mm and the length of the rod was 233.4 mm. The melt viscosity is typically determined at a temperature of 310° C.

Tensile Modulus, Tensile Stress at Break, and Tensile strain at Break: Tensile properties may be tested according to ISO 527-2/1A:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min.

Flexural Modulus, Flexural Stress at Break, and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

### Comparative Examples 1-2

Comparative Examples 1-2 are melt mixed using a 32 mm Coperion co-rotating, fully-intermeshing, twin-screw extruder and include various concentrations of a polyarylene sulfide, glass fibers, black pigment, aminosilane (3-aminopropyl-triethoxysilane), and a mold release additive (Glycolube P, pentaerythritol tetrastearate). The formulations are set forth in more detail in the table below.

| | Comp. Ex. 1 | Comp. Ex. 2 |
|---|---|---|
| | (wt. %) | (wt. %) |
| PPS | 56.97 | 57.05 |
| Glass Fibers | 40 | 40 |
| Black Pigment | 2.5 | 2.5 |
| Aminosilane | 0.33 | 0.25 |
| Glycolube P | 0.2 | 0.2 |

Once formed, the resulting compositions were then injected molded and then tested for various properties as described above. The results are set forth below.

| | Comp. Ex. 1 | Comp. Ex. 2 |
|---|---|---|
| Tensile Modulus (MPa) | 15,148 | 15,367 |
| Tensile Strength (MPa) | 170.21 | 179.94 |
| Tensile Break Strain (%) | 1.41 | 1.46 |
| Flexural Modulus (MPa) | 15,390 | 15,519 |
| Flexural Strength (MPa) | 274 | 288 |
| Charpy Notched at 23° C. (kJ/m²) | 9.2 | — |
| Melt Viscosity T5 at 400 s⁻¹ (Pa-s) | 324.9 | 323.1 |

Parts were also molded with the compositions for use in a film capacitor. Upon visual inspection, the parts had an unacceptable appearance, which is believed to be due to residual deposits from the polymer composition.

### Examples 1-3

Examples 1-3 are melt mixed using a 32 mm Coperion co-rotating, fully-intermeshing, twin-screw extruder and include various concentrations of a polyarylene sulfide, glass fibers, aminosilane (3-aminopropyl-triethoxysilane), black pigment, and zinc stearate. The formulations are set forth in more detail in the table below.

| | Ex. 1 | Ex. 2 | Ex. 3 |
|---|---|---|---|
| | (wt. %) | (wt. %) | (wt. %) |
| PPS | 56.97 | 57.05 | 57.05 |
| Glass Fibers | 40 | 40 | 40 |
| Black Pigment | 2.5 | 2.5 | 2.5 |
| Aminosilane | 0.33 | 0.33 | 0.33 |
| Zinc Stearate | 0.2 | 0.2 | 0.2 |

Once formed, the resulting composition was then injected molded and tested for various properties as described above. The results are set forth below.

| | Ex. 1 | Ex. 2 | Ex. 3 |
|---|---|---|---|
| Tensile Modulus (MPa) | 15,281 | 15,548 | 15,775 |
| Tensile Strength (MPa) | 159.66 | 164.02 | 164.24 |
| Tensile Break Strain (%) | 1.29 | 1.29 | 1.30 |
| Flexural Modulus (MPa) | 15,329 | 15,674 | 15,567 |
| Flexural Strength (MPa) | 263 | 259 | 267 |
| Charpy Notched at 23° C. (kJ/m²) | 8.5 | 8.6 | — |
| Melt Viscosity T5 at 400 s⁻¹ (Pa-s) | 352.8 | 349.8 | 310.4 |

Parts were also molded with the compositions for use in a film capacitor. Upon visual inspection, the parts had an acceptable appearance.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A film capacitor comprising:
a capacitor element that includes first metallized films electrically connected to a first termination and second metallized films electrically connected to a second termination;
a case within which the capacitor element is disposed, wherein the case contains a polymer composition that includes 100 parts by weight of a polymer matrix that contains a polyarylene sulfide, from about 30 to about 90 parts by weight of inorganic fibers, and a zinc (II) compound.

2. The film capacitor of claim 1, wherein the zinc (II) compound includes a zinc carboxylate.

3. The film capacitor of claim 2, wherein the zinc carboxylate includes zinc stearate.

4. The film capacitor of claim 1, wherein the zinc (II) compound includes a zinc oxide.

5. The film capacitor of claim 1, wherein the zinc (II) compound has a melting point and flash point greater than about 85° C.

6. The film capacitor of claim 1, wherein the polymer composition is free of mold release additives having a melting point below about 75° C.

7. The film capacitor of claim 1, wherein the polymer composition is formed by a process that includes melt compounding the polymer matrix and inorganic fibers in the presence of from about 0.05 to about 3 parts by weight the zinc (II) compound per 100 parts by weight of the polymer matrix.

8. The film capacitor of claim 7, wherein the process further includes melt compounding the polymer matrix and inorganic fibers in the presence of from about 0.1 to about 3 parts by weight of an organosilane compound.

9. The film capacitor of claim 1, wherein the polymer matrix constitutes from about 30 wt. % to about 75 wt. % of the polymer composition.

10. The film capacitor of claim 1, wherein the polyarylene sulfide is a polyphenylene sulfide.

11. The film capacitor of claim 10, wherein the polyarylene sulfide is a linear polyphenylene sulfide.

12. The film capacitor of claim 1, wherein the inorganic fibers include glass fibers.

13. The film capacitor of claim 1, further comprising a resinous material that is in contact with the capacitor element and the case and disposed in the space, wherein the resinous material includes a thermoset resin.

14. The film capacitor of claim 13, wherein the thermoset resin includes an epoxy resin.

15. The film capacitor of claim 13, wherein the resinous material further includes an inorganic oxide filler.

16. An electric vehicle comprising a powertrain that includes at least one electric propulsion source and a transmission that is connected to the propulsion source via at least one power electronics module, wherein the electric vehicle comprises the film capacitor of claim 1.

17. The electric vehicle of claim 16, wherein the power electronics module comprises the film capacitor.

18. The electric vehicle of claim 17, wherein the power electronics module includes an inverter that converts direct current to alternating current, wherein the inverter includes the film capacitor.
